(19) United States
(12) Patent Application Publication
(10) Pub. No.: US 2013/0078858 A1
(43) Pub. Date: Mar. 28, 2013

(54) ELECTRICAL CONNECTOR WITH IMPROVED GROUNDING

(71) Applicants: ZHUANG-ZHI WU, Kunshan (CN); PING-SHENG SU, New Taipei (TW); XUE-CHAO WANG, Kunshan (CN)

(72) Inventors: ZHUANG-ZHI WU, Kunshan (CN); PING-SHENG SU, New Taipei (TW); XUE-CHAO WANG, Kunshan (CN)

(73) Assignee: HON HAI PRECISION INDUSTRY CO., LTD., New Taipei (TW)

(21) Appl. No.: 13/624,977

(22) Filed: Sep. 24, 2012

(30) Foreign Application Priority Data
Sep. 22, 2011 (CN) 201110283340.6

(51) Int. Cl. H01R 13/6592

(52) U.S. Cl. 439/607.41

(57) ABSTRACT

An electrical connector comprises: an insulative housing, a number of conductive terminals received in the insulative housing, a metal shell having four walls enclosing the insulative housing, and a cable comprising a number of wires connected electrically respectively to the conductive terminals and a braid layer forming a linear structure. The braid layer is soldered to an inner surface of the metal shell walls.

### FIELD OF THE INVENTION

The present invention relates to an electrical connector, and more particularly to an electrical connector having signal transmission well.

### DESCRIPTION OF PRIOR ART

As a main carrier of data and signal transmission, the USB type connector has been a rapid development. With the birth of the USB 2.0, the Mini USB, the Micro USB and the USB 3.0 connector, the demand of the quality and the speed of data transmission is increasingly high. At the same time, the requirement of the overall structure of the connector is more and more miniaturization and simplistic.

Currently, the USB type connector comprises a housing, a plurality of conductive terminals received in the housing, a shell enclosing the housing, and a cable. The cable includes a number of electricity wires and signal wires. The conductive terminals are composed of a number of electricity terminals connected to the electricity wires and signal conductive terminals connected to the signal wires. Although the connection of the electricity wires and the electricity terminals can ensure the quality and stability of signal transmission of traditional connector, it may be not sufficient when the signal transmission speed is very high while the connector is very small.

U.S. Patent Application Publication No. 2012/0028496A1, published on Feb. 2, 2012, discloses a cable connector assembly including a grounding flake. The grounding flake plays a role of a bridge connecting a braid layer and a metal shell of the cable connector assembly. The connection can meet the grounding requirement of said cable connector assembly. However, if the volume of the cable connector assembly is smaller, the metal shell may not form a location for receiving the grounding pin.

Furthermore, Taiwan Pat. No. TWM397636, issued on Feb. 1, 2011, disclosed an electrical connection device having a structure that a braid layer is used for grounding and comprising a connector and the braid layer. The connector defines a metal shell and a body portion extending outwardly from an end of the metal shell. The body portion having a bend and forming a slot. The braid wire is sandwiched and retained into the slot of the body portion. An end of the braid wire is crimped in the body, and the braid wire is electrically connected to the body connector. The device has a good grounding effect, but the body portion increases significantly the volume of the device. It is not in accordance with the development trend of the miniaturization of the connector. If the extension of the body portion in technical solutions is applied to a plug connector, the plug connector must increase a cover enclosing the body portion to increase cost.

As discussed above, an improved electrical connector overcoming the shortages of existing technology is needed.

### SUMMARY OF THE INVENTION

Accordingly, an object of the present invention is to provide an electrical connector having improved signal transmission.

In order to achieve the above-mentioned objects, an electrical connector comprises: an insulative housing, a plurality of conductive terminals received in the insulative housing, a metal shell having four walls enclosing the insulative housing, and a cable comprising a number of wires connected electrically respectively to the conductive terminals and a braid layer forming a linear structure. The braid layer is soldered to an inner surface of the metal shell walls.

Other objects, features and advantages of the invention will be apparent from the following detailed description taken in connection with the accompanying drawings.

### BRIEF DESCRIPTION OF THE DRAWINGS

FIG. 1 is an exploded, perspective view of an electrical connector in accordance with the present invention;

FIG. 2 is a view similar to FIG. 1, but from another aspect;

FIG. 3 is a partially assembled, perspective view of the electrical connector shown in the FIG. 1; and

FIG. 4 is a perspective view of the electrical connector shown in the FIG. 3.

### DETAILED DESCRIPTION OF PREFERRED EMBODIMENTS

Reference will now be made to the drawing figures to describe the present invention in detail.

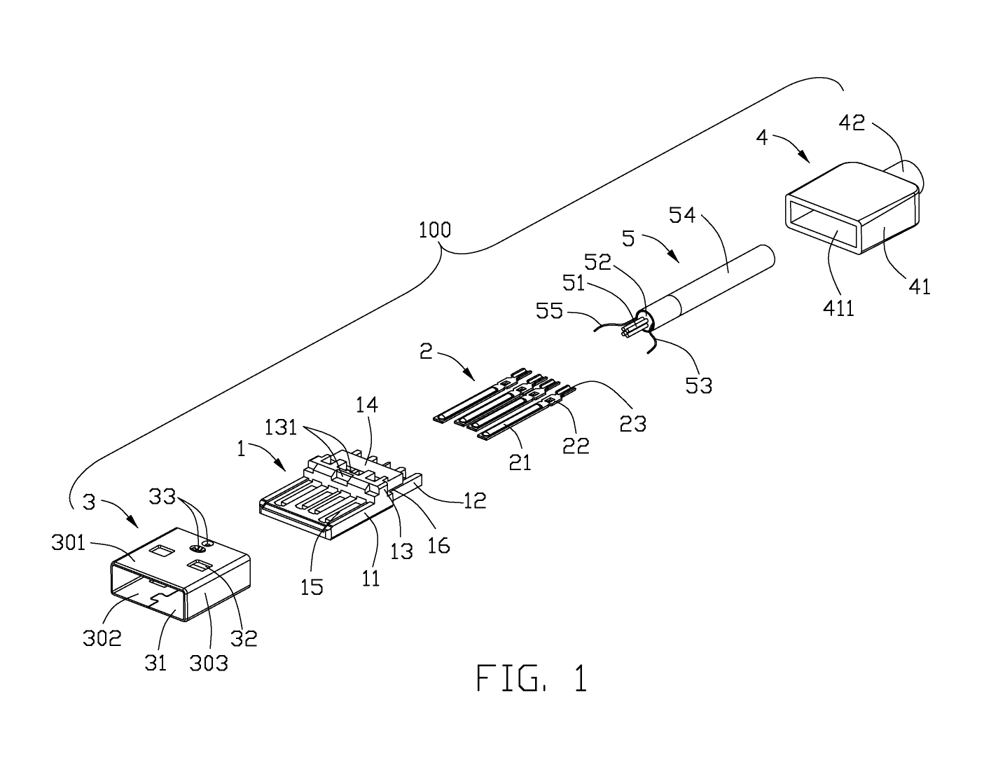

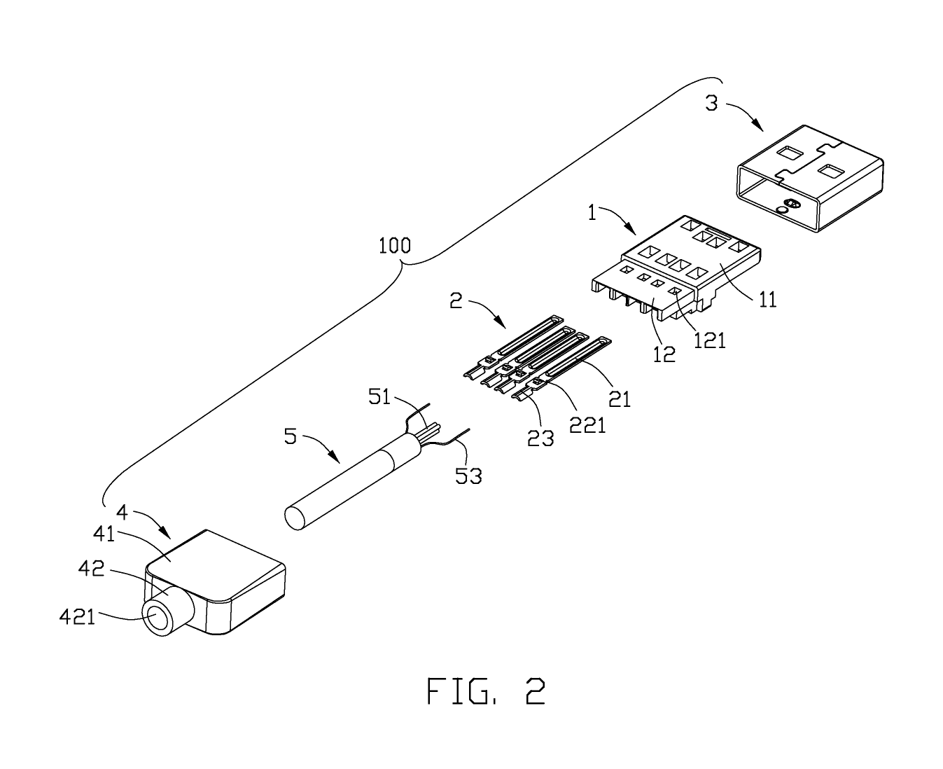

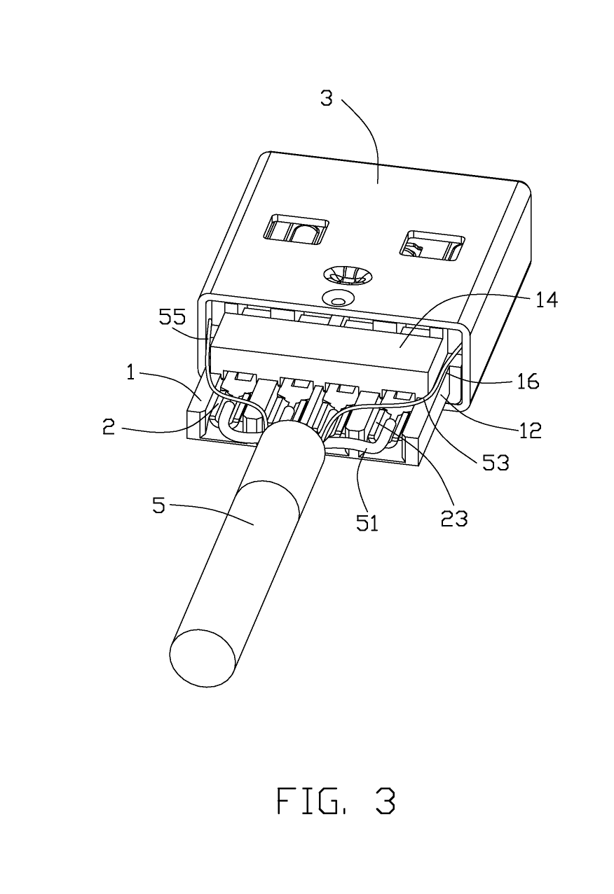

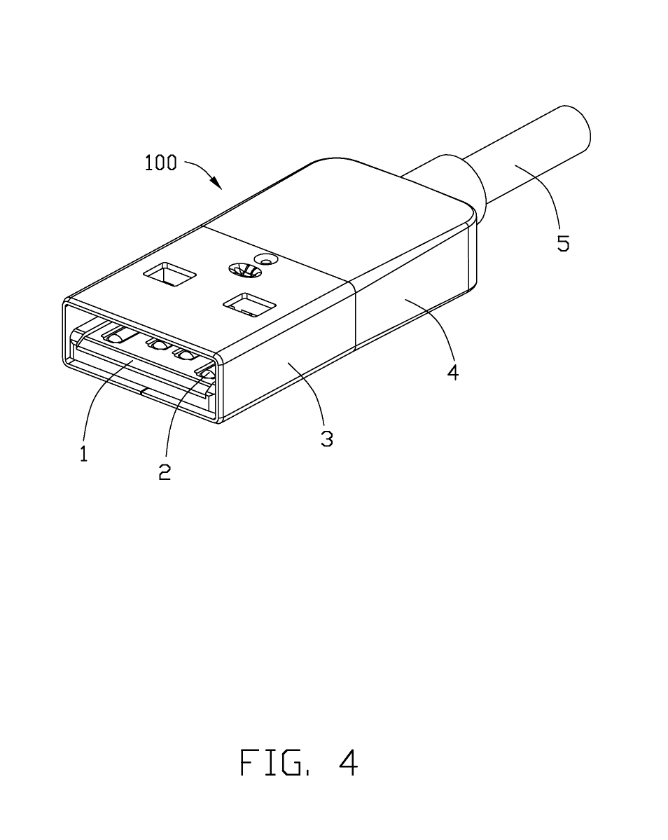

Referring to FIGS. 1 to 4, an electrical connector 100 in accordance with the present invention comprises an insulative housing 1, a plurality of conductive terminals 2 received in the insulative housing 1 and a metal shell 3 enclosing the insulative housing 1, a cover 4 mounted behind the metal shell 3, and a cable 5 electrically connected to the conductive terminals 2. In this embodiment, the electrical connector 100 meets the USB 2.0 standard.

The insulative housing 1 comprises a main portion 11 and a connecting portion 12 extending rearwardly from the main portion 11. A bottom face and two lateral faces of the connecting portion 12 are recessed inwardly relative to a bottom face and two lateral faces of the main portion, respectively. A flange 13 is raised upwardly from a rear end of the main portion 11. A platform 14 is raised upwardly from a front end of the connecting portion 12 and connected to the flange 13. The flange 13 is higher than the platform 14. A plurality of terminal slots 15 recessed forwardly from a rear face of the housing 1 are beyond to the flange 13. The terminal slots 15 are exposed on upper faces of the main portion 11 and the connecting portion 12. The flange 13 and the platform 14 are located above the terminal slots 15. A pair of fastening slots 131 are recessed downwardly from an upper face of the flange 12 and arrangement along a front-to-rear direction. A number of retaining slots 121 are recessed upwardly from the bottom face of the connecting portion 12. The retaining slots 121 are communicated with the terminal slots 15, respectively. The insulative housing 1 has an avoiding slot 16 on the rear end thereof The avoiding slot 16 can located at/on two lateral side of the platform 14, or between the platform 14 and connecting portion 12.

Each conductive terminal 2 comprises a retaining portion 22, a mating portion 21 extending forwardly from the retaining portion 22 and a soldering portion 23 extending rearwardly from the retaining portion 22. The retaining portion 22 has a retaining pin 221 by means of stamping and extending rearwardly inclined from the bottom surface thereof The conductive terminals 2 are composed of a pair of signal terminals (not labeled) and a pair of electricity terminals (not labeled).

The metal shell 3 has a receiving space 31 by four walls surrounding. The walls comprises upper wall 301, a lower wall 302 opposite to the upper wall 301 and a pair of lateral walls connected the upper wall 301 to the lower wall 302. At least a pair of retaining holes 32 are run through the upper wall 301 and the lower wall 302 and communicated with the receiving space 31. A pair of notches 33 are recessed downwardly from the upper wall 301 and located on the rear end of the upper wall 301 along the front-to-rear direction. The bottom of the notches 33 is raised toward the receiving space 31.

The cover 4 is made of plastic injection molding, and comprises a receiving portion 41 located on a front end thereof and having a receiving cavity 411, and a protecting portion 42 located behind the receiving portion 31. The protecting portion 42 has a through hole 421 communicated with the receiving cavity 411.

The cable 5 comprises a number of wires 51, an inner insulative skin 52 enclosing the wires 51, a braid layer 53 enclosing the inner insulative skin 52 and an outer insulative skin 54 enclosing the braid layer 53. The wires 51 are beyond to the front end of the inner insulative skin 52. A linear structure is formed by the braid layer 53 located on the front of the outer insulative skin 54. That is, the braid layer 53 is twisted into a bundle of wires. The wires 51 define signal wires (not labeled) and electricity wires (not labeled). The cable 5 further comprises a grounding line 55 contacted with the braid layer 53 in the outer insulative skin 54.

In assembly, the conductive terminals 2 are enclosed in the insulative housing 1. Each conductive terminal 2 is received in the terminal slot 15, and the mating portion 21 of the conductive terminal 2 is exposed out of the terminal slot 15, and the soldering portion 23 is located in the connecting portion 12, and the retaining pin 221 of retaining portion 22 is received in the retaining slot 121 for retaining the conductive terminal 2. The wires 51 of the cable 5 are respectively soldered on the soldering portion 23. The signal wires are connected to the signal terminals, and the electricity wires are connected to the electricity terminals. The metal shell 3 is mounted on the housing 1. The main portion 11 of the housing 1 is received in the metal shell 3, and the connecting portion 13 is beyond to the rear face of the metal shell 3. The bottom of the notches 33 of the metal shell 3 are respectively engaged into the fastening slots 131 of the flange 13 of the housing 1. The flange 13 is received in the metal shell 3. The rear face of the metal shell 3 is alignment to the rear face of the main portion 11. The braid layer 53 is soldered on the inner surface of the metal shell 3. The soldered point which the braid layer 53 is soldered on the metal shell 3 is located within four walls. The braid layer 53 which is formed the linear structure is received in the avoided slot 16 of the housing 1. In other embodiments, an avoided space can be formed between the connecting portion 12 of the housing 1 and the metal shell 3 for receiving the braid layer 53. The braid layer 53 penetrates the avoided space and is soldered on the inner surface of the metal shell 3. The cover 4 is interference with and mounted on the housing 1. The cover 4 is glued to connect to the metal shell 3. The receiving cavity 411 receives the connecting portion 12 and the platform 14. The front end of the cover 4 is attached to the rear end of the metal shell 3. The outer surface of the cover 4 is alignment to the outer surface of the metal shell 3 to make the width of the cross-section of the electrical connector 100 same along the front-to-rear direction. The protecting portion 42 encloses the cable 5.

In present invention, both the braid layer with the linear structure located in front of the inner insulative skin and the grounding line are soldered on the inner surface of the metal shell together to not increase the outside dimension of the electrical connector, and make the signal transmission better. It may be needed to an outer cover enclose the metal shell for protecting the soldered point.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. An electrical connector, comprising:
an insulative housing,
a plurality of conductive terminals received in the insulative housing,
a metal shell having four walls enclosing the insulative housing, and
a cable comprising a number of wires connected electrically respectively to the conductive terminals and a braid layer forming a linear structure; wherein
the braid layer is soldered to an inner surface of the metal shell walls.

2. The electrical connector as recited in claim 1, wherein an avoiding slot is formed on a rear end of the housing.

3. The electrical connector as recited in claim 2, wherein the braid layer with the linear structure is received in the avoiding slot.

4. The electrical connector as recited in claim 1, wherein an avoiding space is defined between the metal shell and the housing for being penetrated by the braid layer with the linear structure.

5. The electrical connector as recited in claim 1, wherein the braid layer is soldered on the metal shell from at least one of two lateral sides of the insulative housing.

6. The electrical connector as recited in claim 1, wherein the electrical connector further comprises a cover mounted behind the rear end of the insulative housing.

7. The electrical connector as recited in claim 6, wherein an outer face of the cover is alignment to an outer face of the metal shell.

8. The electrical connector as recited in claim 6, wherein the cover is glued for connecting to the metal shell.

9. The electrical connector as recited in claim 6, wherein a front face of the cover is attached to a rear face of the metal shell.

10. The electrical connector as recited in claim 6, wherein the cover has a protecting portion enclosing the cable.

11. The electrical connector as recited in claim 1, wherein the cable further comprises a grounding line contacted with the braid layer.

12. The electrical connector as recited in claim 11, wherein the grounding line is soldered on a second lateral side opposite to the first lateral side.

13. An electrical connector comprising:
an insulative housing defining a front mating portion and a rear connecting portion;
a plurality of terminals disposed in the housing, each of said terminals defining a front mating section exposed in the front mating portion, and a rear connecting section exposed upon the rear connecting portion;
a metallic shell enclosing only the front mating portion without the rear connecting portion, and defining a same cross-section along a front-to-back direction;
a cable including a plurality of wires respectively connected to the rear connecting sections of the corresponding terminals, and further including a braiding layer surrounding said wires; wherein
said braiding layer is shrunk as a wire around a front end thereof to mechanically and electrically connect to the shell at a position which is located in front of the connecting sections in said front-to-back direction.

14. The electrical connector as claimed in claim 13, wherein said cable further includes a grounding wire which is mechanically and electrically connected to the shell at another position which is locate in front of the connecting sections in said front-to-back direction.

15. The electrical connector as claimed in claim 13, wherein said position is located around a longitudinal end of the shell in a longitudinal direction perpendicular to said front-to-back direction.

16. The electrical connector as claimed in claim 15, wherein said position is located on an inner side of the shell.

17. The electrical connector as claimed in claim 15, wherein said cable further includes a grounding wire which is mechanically and electrically connected to the shell at another position which is locate in front of the connecting sections in said front-to-back direction and around another longitudinal end of the shell in said longitudinal direction.

18. The electrical connector as claimed in claim 17, wherein both said position and said another position are located on an inner side of the shell.

19. The electrical connector as claimed in claim 18, wherein an insulative cover is overmolded on the rear connecting portion to enclose the wire formed by the braiding layer.

20. An electrical connector comprising:
an insulative housing defining a front mating portion and a rear connecting portion;
a plurality of terminals disposed in the housing, each of said terminals defining a front mating section exposed in the front mating portion, and a rear connecting section exposed upon the rear connecting portion;
a metallic shell enclosing only the front mating portion without the rear connecting portion; and
a cable including a plurality of wires respectively connected to the rear connecting sections of the corresponding terminals, and further including a braiding layer surrounding said wires; wherein
said braiding layer is shrunk as a wire around a front end thereof to mechanically and electrically connect to the shell at a position which is located on an inner side of the shell and in front of the connecting sections in said front-to-back direction, and an insulative cover is overmolded on the rear connecting portion to enclose said wire formed by the braiding layer.
